(19) United States
(12) Patent Application Publication
(10) Pub. No.: US 2015/0126197 A1
(43) Pub. Date: May 7, 2015

(54) METHOD AND ITS APPARATUS FOR CONTROLLING SMS IN COMMUNICATION SYSTEM

(71) Applicant: Samsung Electronics Co., Ltd., Suwon-si (KR)

(72) Inventor: Song-Hak LEE, Seoul (KR)

(21) Appl. No.: 14/534,561

(22) Filed: Nov. 6, 2014

(30) Foreign Application Priority Data
Nov. 6, 2013 (KR) 10-2013-0134115

(51) Int. Cl. H04W 4/14; H04W 36/00

(52) U.S. Cl. CPC H04W 4/14; H04W 36/0083; H04W 88/08
USPC 455/437; 455/561

(57) ABSTRACT

A method and an apparatus for controlling a Short Message Service (SMS) in a communication system are provided. The method includes receiving the SMS message for a first terminal, in response to receiving the SMS message, detecting a handover event for the first terminal during a predetermined time, and if the handover event is detected, triggering a handover of the first terminal after the predetermined time.

### CROSS-REFERENCE TO RELATED APPLICATION(S)

This application claims the benefit under 35 U.S.C. §119(a) of a Korean patent application filed on Nov. 6, 2013 in the Korean Intellectual Property Office and assigned Serial number 10-2013-0134115, the entire disclosure of which is hereby incorporated by reference.

### TECHNICAL FIELD

The present disclosure relates to a method and apparatus for transmitting a message in a handover process of a terminal.

### BACKGROUND

With the widespread adoption of mobile phones in recent years, the number of users who use text services has been rapidly increased. In particular, a Short Message Service (SMS) which is a text service capable to exchanging a text consisting of about 40 characters has emerged as a service used by most mobile phone users.

In general, an SMS message is transmitted using a Non Access Stratum (NAS) protocol. For example, a user terminal transmits an NAS message including the SMS message to a base station, and the base station delivers the received NAS message to another terminal via a higher layer node without having to separately process the NAS message. That is, the NAS message is delivered to another terminal or a higher layer network via the base station, the SMS message may experience a transmission delay or failure according to a situation of the base station. For example, if SMS message transmission is requested from the user terminal during a handover, since the base station preferentially processes the handover, the SMS message transmission may fail.

Accordingly, a failure in the SMS message transmission frequently occurs. When the SMS message transmission fails, a user inconveniently has to retransmit the SMS message.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for transmitting a Short Message Service (SMS) in a handover process by a base station.

Another aspect of the present disclosure is to provide a method and apparatus for identifying an SMS message on the basis of protocol discriminator information of a Non Access Stratum (NAS) message and for ensuring SMS transmission by a base station.

Another aspect of the present disclosure is to provide a method and apparatus for delaying a handover until completing SMS message transmission when a handover event is detected during the SMS message transmission.

Another aspect of the present disclosure is to provide a method and apparatus for determining whether a handover is delayed until a time of completing SMS message transmission on the basis of a handover event type when a handover event is detected by a base station during the SMS message transmission.

In accordance with an aspect of the present disclosure, a method of a base station for transmitting an SMS message is provided. The method includes receiving the SMS message for a first terminal, in response to receiving the SMS message, detecting a handover event for the first terminal during a predetermined time, and if the handover event is detected, triggering a handover of the first terminal after the predetermined time.

In accordance with another aspect of the present disclosure, a base station for transmitting an SMS message is provided. The base station includes a communicator for transmitting and receiving a message, an SMS transmission configured to receive the SMS message for a first terminal, and a handover controller for detecting a handover event for the first terminal during a predetermined time, in response to receiving the SMS message, and for triggering a handover of the first terminal after the predetermined time.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of a base station for transmitting a Short Message Service (SMS) message when a handover is detected according to an embodiment of the present disclosure;

FIG. 2A is a flowchart illustrating a procedure of processing a handover and an SMS message by a base station according to an embodiment of the present disclosure;

FIG. 2B illustrates a means for processing a handover and an SMS message by a base station according to an embodiment of the present disclosure;

FIG. 3 illustrates a signal flow for transmitting an SMS message when a handover event is detected by a base station according to an embodiment of the present disclosure;

FIG. 4 illustrates a signal flow for transmitting an SMS message when a handover event is detected by a base station according to another embodiment of the present disclosure;

FIG. 5 is a flowchart illustrating a procedure for determining whether to perform a handover trigger on the basis of a handover event type when a handover event is detected according to an embodiment of the present disclosure;

FIGS. 6A and 6B illustrate a frame structure of a Non Access Stratum (NAS) message according to an embodiment of the present disclosure; and

FIG. 7 illustrates a structure of context information for a terminal managed by a base station according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An expression “have”, “may have”, “include” or “may include” or the like used in the present document is intended to indicate a presence of a corresponding characteristic (e.g., a number, a function, an operation, or a constitutional element such as a component), and should be understood that there are additional possibilities of one or more other characteristics.

In the present disclosure, an expression “A or B”, “A and/or B”, or “one or more of A and/or B” or the like may include all possible combinations of items enumerated together. For example, “A or B”, “at least one of A and B”, or “at least one of A or B” may indicate all cases where (1) at least one A is included, (2) at least one B is included, and (3) at least one A and at least one B are both included.

Although expressions used in various embodiments of the present disclosure such as “1st”, “2nd”, “first”, “second” or the like may be used to express various constitutional elements, it is not intended to limit an order and/or importance thereof. The above expressions may be used to distinguish one element from another element. For example, a 1st user device and a 2nd user device may indicate different user devices irrespective of an order or importance thereof. For example, a 1st element may be termed a 2nd element, and similarly, the 2nd element may be termed the 1st element without departing from the scope of the present disclosure.

When a certain element (e.g., the 1st element) is mentioned as being “operatively or communicatively coupled with/to” or “connected to” a different element (e.g., the 2nd element), it is to be understood that the certain element is directly coupled with/to another element or can be coupled with/to the different element via another element (e.g., a 3rd constitutional element). On the other hand, when the certain element (e.g., the 1st element) is mentioned as being “directly coupled with/to” or “directly connected to” the different element (e.g., the 2nd element), it may be understood that another element (e.g., the 3rd constitutional element) is not present between the certain element and the different element.

An expression “configured to” used in the present disclosure may be interchangeably used with, for example, “suitable for”, “having the capacity to”, “designed to”, “adapted to”, “made to”, or “capable of” according to a situation. A term “configured to” may not imply only “specially designed to” in a hardware manner. Instead, in a certain situation, an expressed “a device configured to” may imply that the device is “capable of” together with other devices or components. For example, “a processor configured to perform A, B, and C” may imply a dedicated processor (e.g., an embedded processor) for performing a corresponding operation or a generic-purpose processor (e.g., Central Processing Unit (CPU) or an application processor) capable of performing corresponding operations by executing one or more software programs stored in a memory device.

Terms used in the present disclosure are for the purpose of describing particular embodiments only and are not intended to limit other embodiments. A singular expression may include a plural expression unless there is a contextually distinctive difference. Unless otherwise defined, all terms (including technical and scientific terms) used herein have the same meaning as commonly understood by those ordinarily skilled in the art to which various embodiments of the present disclosure belong. It will be further understood that terms, such as those defined in commonly used dictionaries, should be interpreted as having a meaning that is consistent with their meaning in the context of the relevant art, and will not be interpreted in an idealized or overly formal sense unless expressly so defined herein. Optionally, the terms defined in the present document should not be interpreted to exclude the various embodiments of the present disclosure.

An electronic device according to various embodiments of the present disclosure may include a smart phone, a tablet Personal Computer (PC), a mobile phone, a video phone, an e-book reader, a desktop PC, a laptop PC, a netbook computer, a workstation, a server, a Personal Digital Assistant (PDA), a Portable Multimedia Player (PMP), an MPEG-1 Audio Layer 3 (MP3) player, a mobile medical device, a camera, and a wearable device (e.g., smart glasses, a Head-Mounted-Device (HMD), electronic clothes, an electronic bracelet, an electronic necklace, an electronic accessory, an electronic tattoo, a smart mirror, or a smart watch).

According to various embodiments of the present disclosure, the electronic device may be a smart appliance. For example, the smart appliance may include a TeleVision (TV), a Digital Video Disk (DVD) player, an audio, a refrigerator, an air conditioner, a cleaner, an oven, a microwave oven, a washing machine, an air purifier, a set-top box, a home automation control panel, a security control panel, a TV box (e.g., Samsung HomeSync™, Apple TV™, or Google TV™), a game console (e.g., Xbox™, PlayStation™), an electronic dictionary, an electronic key, a camcorder, and an electronic picture frame.

According to various embodiments of the present disclosure, the electronic device may include at least one of various medical devices such as, for example, various portable medical measurement devices (i.e., a blood glucose monitoring device, a heart rate monitoring device, a blood pressure measuring device, a body heat measuring device, etc.), Magnetic Resonance Angiography (MRA), Magnetic Resonance Imaging (MRI), Computed Tomography (CT), imaging equipment, ultrasonic instrument, etc. The electronic device may also include a navigation device, a Global Positioning System (GPS) receiver, an Event Data Recorder (EDR), a Flight Data Recorder (FDR), a car infotainment device, an electronic equipment for a ship (e.g., a vessel navigation device, a gyro compass, etc.), avionics, a security device, an industrial or domestic robot, an Automatic Teller Machine (ATM) of a financial institution, a Point Of Sales (POS) of a retail shop, and devices associated with the Internet of things (e.g., a light bulb, various sensors, an electric or gas meter, a sprinkler device, a fire alarm, a thermostat, a streetlamp, a toaster, fitness equipment, a hot water tank, a heater, a boiler, etc.).

According to various embodiments of the present disclosure, the electronic device may include furniture, a part of a building/construction, an electronic board, an electronic signature receiving device, a projector, and various measurement machines (e.g., water supply, electricity, gas, propagation measurement machine, etc.). In various embodiments of the present disclosure, the electronic device may be one or more combinations of the aforementioned various devices. In an embodiment of the present disclosure, the electronic device may be a flexible device. In addition, the electronic device according to the various embodiments of the present disclosure is not limited to the aforementioned devices, and may include a new electronic device based on technical advances.

Hereinafter, an electronic device according to various embodiments of the present disclosure will be described with reference to the accompanying drawings. In the present document, a term ‘user’ may refer to a person who uses the electronic device or a device which uses the electronic device (e.g., an Artificial Intelligence (AI) electronic device).

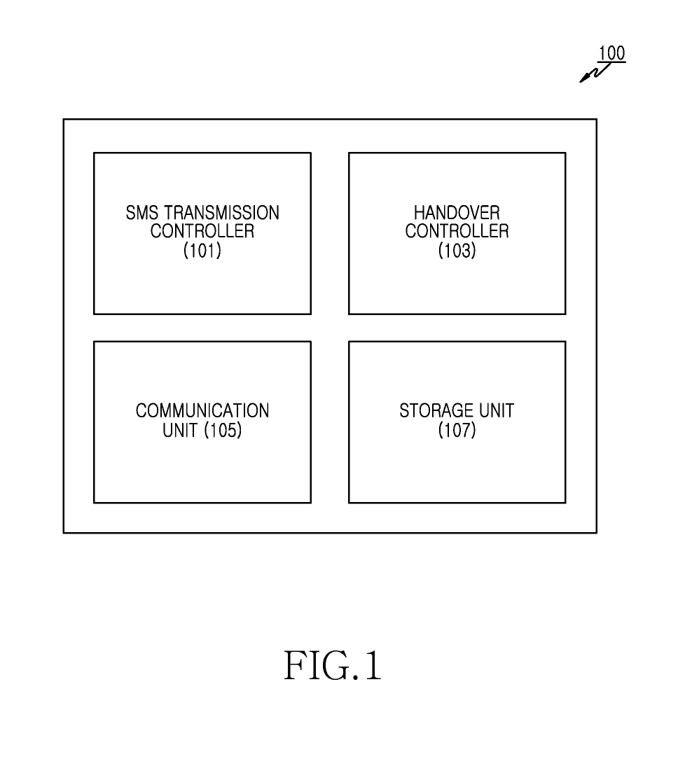

FIG. 1 is a block diagram of a base station for transmitting a Short Message Service (SMS) message when a handover is detected according to an embodiment of the present disclosure.

Referring to FIG. 1, the base station 100 includes an SMS transmission controller 101, a handover controller 103, a communication unit 105, and a storage unit 107.

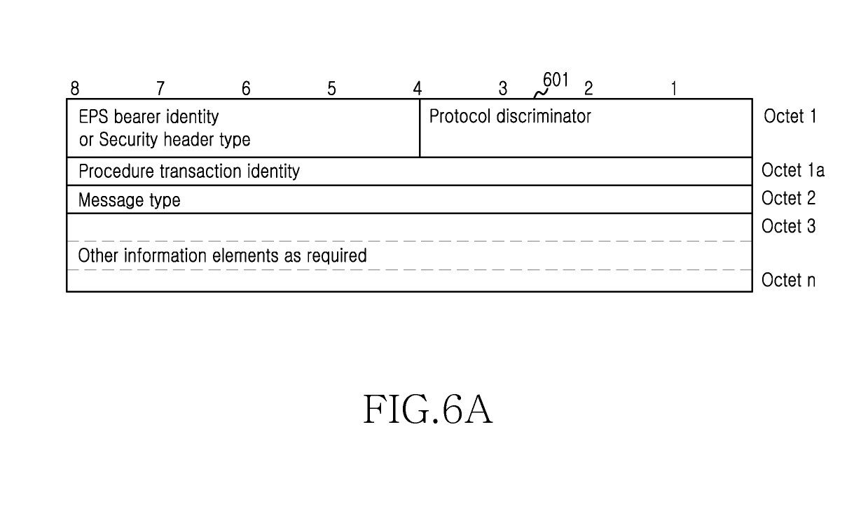

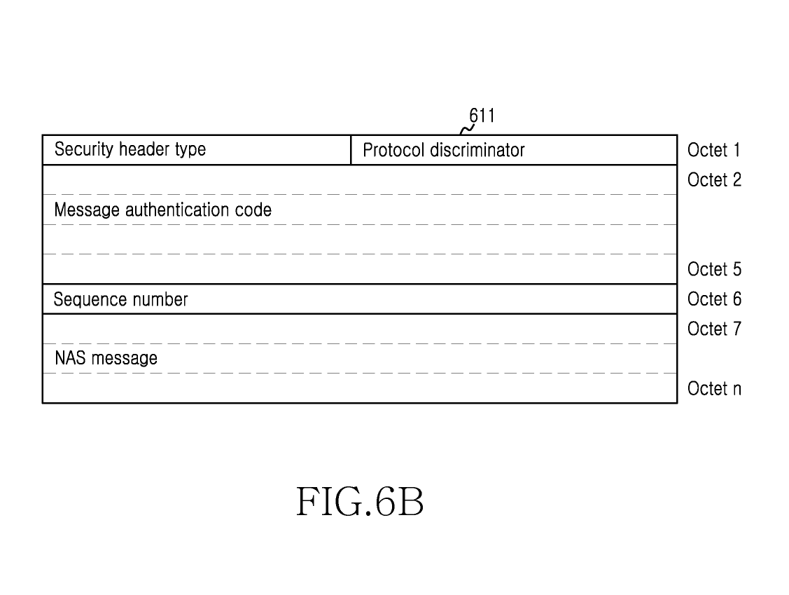

The SMS transmission controller 101 receives a Non Access Stratum (NAS) message from a terminal or a higher network node (e.g., a Mobile Management Entity (MME)), and may determine if the received NAS message is an SMS message. More specifically, the SMS transmission controller 101 may determine if protocol discriminator information included in the received NAS message indicates that the message is the SMS message. If a protocol discriminator field has a bit pattern ‘1001’, which indicates that the message is the SMS message, the SMS transmission controller 101 may confirm that the NAS message is the SMS message. For example, in a case where an uplink NAS message is received from the terminal coupled to a base station 100, the SMS transmission controller 101 may determine that the received uplink NAS message is the SMS message if a bit pattern of a protocol discriminator included in the received message is ‘1001’, and may determine that the received uplink NAS message is not the SMS message if the bit pattern of the protocol discriminator is not ‘1001’. In another example, in a case where a downlink NAS message is received from the MME, the SMS transmission controller 101 may determine that the received downlink NAS message is the SMS message if a bit pattern of a protocol discriminator included in the received message is ‘1001’, and may determine that the received downlink NAS message is not the SMS message if the bit pattern of the protocol discriminator is not ‘1001’. For example, similar to a plain NAS message shown in FIG. 6A and a security protected NAS message shown in FIG. 6B, protocol discriminator information 601 and 611 is included in all NAS message headers, and even if a corresponding NAS message is encrypted, the base station can determine the protocol discriminator without an additional restriction.

In addition, if the NAS message is confirmed to be an SMS message, the SMS transmission controller 101 may run a handover delay timer for delaying a handover during SMS message transmission. In addition, the SMS transmission controller 101 may transmit the SMS message before the handover delay timer expires. In this case, the SMS transmission controller 101 may transmit the SMS message by using a SMS message transmission technique. For example, if an outgoing SMS message is to be transmitted from a first terminal, which is currently served by the base station, the SMS transmission controller 101 may run a handover delay timer for the first terminal, and may transmit messages (e.g., an SMS message, a response message for the SMS message, etc.) required for successful transmission of the outgoing SMS message to the first terminal or an MME before the handover delay timer for the first terminal expires. For another example, upon reception of an incoming SMS message for the first terminal served by the base station from a Short Message Service Center (SMSC) via the MMS, the SMS transmission controller 101 may run the handover delay timer for the first terminal, and may transmit messages (e.g., an SMS message, a response message for the SMS message, etc.) required for successful transmission of the incoming SMS message to the first terminal or the MME before the handover delay timer for the first terminal expires. The handover delay timer may be configured such that a threshold time is measured by an operator or a designer. In this case, the threshold time may be set to a time to provide successful an SMS message transmission procedure.

The handover controller 103 may detect a handover of the terminal coupled to the base station 100. More specifically, the handover controller 103 may detect a handover event by receiving a measurement report message for reporting an occurrence of the handover event from the terminal. In this case, the received measurement report message may include information indicating a handover event type. For example, the measurement report message may include event A3 type information to report that the terminal detects neighboring cell's signal strength that is greater by a first offset (e.g., a3offset) than or equal to serving cell's signal strength. For another example, the measurement report message may include event A5 type information to report that serving cell's signal strength received by the terminal is less than or equal to a first threshold and neighboring cell's signal strength is greater than or equal to a second threshold. Herein, a first offset of an event A3 and first and second thresholds for an event A5 may be transmitted in advance by the base station to a corresponding terminal. For example, the base station may transmit conditions for an event type to the terminal by using a Radio Resource Connection (RRC) connection reconfiguration message. In addition, the first and second thresholds of the event A5 may be set to values which are satisfied in a situation where the terminal is no longer able to stay in a serving cell.

Upon detection of a handover from the SMS transmission controller 101 when the handover delay timer is running, the handover controller 103 may confirm a handover event type based on the handover event type information included in the received measurement report message. For example, upon detection of the handover, the handover controller 103 may confirm that the event type of the handover is the A3 type or the A5 type based on the handover event type information included in the measurement report message.

The handover controller 103 may determine a handover trigger according to the handover event type. For example, the handover controller 103 may delay the handover trigger during execution of the handover delay timer if the handover event type is A3, and may determine to trigger the handover immediately irrespective of the handover delay timer if the handover event type is A5. For example, if the handover event type is A3 and the handover controller 103 determines that the handover delay timer expired, the handover controller 103 may immediately trigger the handover. However, if the handover delay timer has not expired, the handover controller 103 may delay the handover process until the handover delay timer expires. In this case, the delaying of the handover process implies waiting instead of transmitting a handover command to the terminal even though a handover request signal and a handover response signal are transmitted and received with respect to a target base station of the terminal. For another example, if the handover event type is A5, the handover controller 103 may confirm whether the handover delay timer expires, and if the handover delay timer expires, may immediately trigger the handover. However, if the handover delay timer does not expire, the handover controller 103 may stop the handover delay timer and immediately trigger the handover.

The communication unit 105 performs a function of transmitting and receiving a signal with respect to the terminal and the MME. For example, the communication unit 105 delivers an SMS-related message received from the terminal to the MME and delivers the SMS-related message received from the MME to the terminal. In addition, the communication unit 105 provides the handover controller 103 with a measurement report message received from the terminal, transmits a handover request message to the target base station, and receives the handover request message from the target base station. In addition, the communication unit 105 may transmit a handover command message to the terminal at a trigger time determined by the handover controller 103.

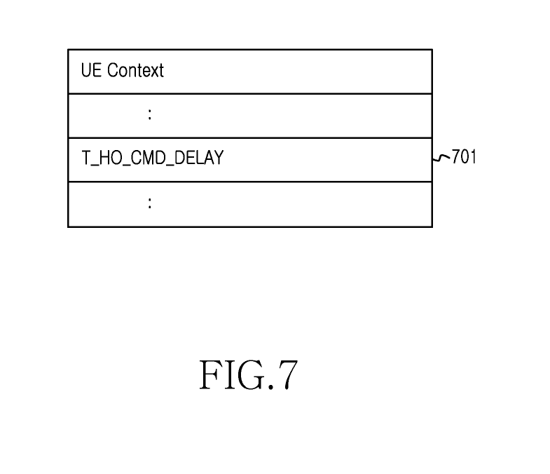

The storage unit 107 may store data and programs required for an overall operation of the base station. The storage unit 107 stores context information of each terminal which receives a service provided from the base station. According to the embodiment of the present disclosure, as shown in FIG. 7, the storage unit 107 additionally stores information of the handover delay timer (i.e., T_HO_CMD_DELAY 701) into the context information of the terminal FIG. 7 illustrates a structure of context information for a terminal managed by a base station according to an exemplary embodiment of the present invention disclosure.

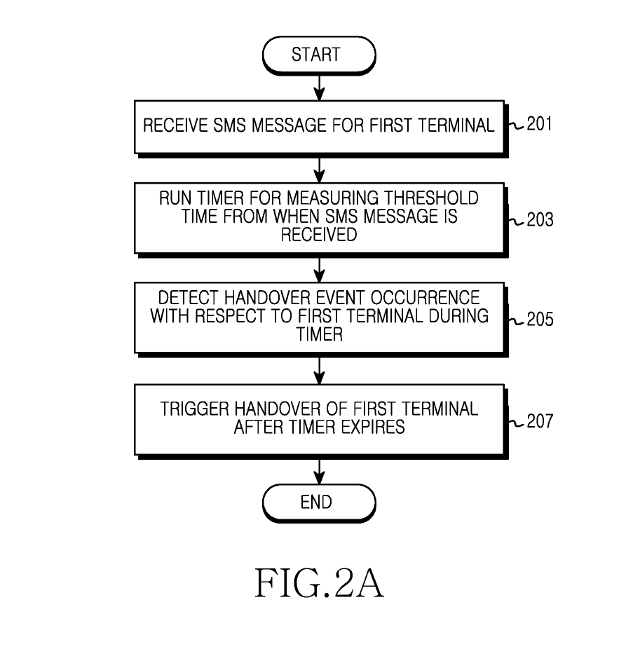

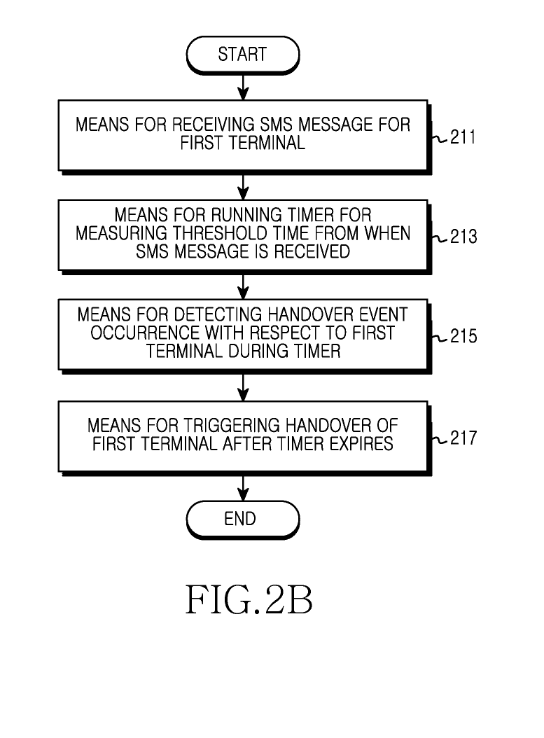

FIG. 2A is a flowchart illustrating a procedure of processing a handover and SMS message by a base station according to an embodiment of the present disclosure.

Referring to FIG. 2A, the base station 100 may receive an SMS message for the first terminal in operation 201. More specifically, the base station 100 may confirm a protocol discriminator included in an uplink NAS message received from the first terminal or a downlink NAS message received from the MME, and may detect reception of the SMS message.

In operation 203, the base station 100 may run a timer for measuring a threshold time from when the SMS message is received. More specifically, the base station 100 may run a handover delay timer at a time of receiving the SMS message in order to delay a handover. In this case, the handover delay timer may be predetermined in a design operation.

In operation 205, the base station 100 may detect a handover event occurrence with respect to the first terminal during the timer. In other words, the base station 100 may detect the handover event occurrence by receiving a measurement report message for reporting the handover event occurrence from the terminal coupled to the base station 100. In this case, the measurement report message may include handover event type information, and the base station 100 may determine a handover event type of the terminal based on the handover event type information.

In operation 207, the base station 100 may trigger a handover of the first terminal after the timer expires. For example, the base station 100 may determine a neighboring base station included in the measurement report message as a target base station to perform the handover of the first terminal, may transmit a handover request message to the target base station and receive a response message thereof, and thereafter may wait until the timer expires and transmit a handover command message to the first terminal after the timer expires.

Thereafter, the base station 100 ends the procedure according to an embodiment of the present disclosure.

FIG. 2B illustrates a means for processing a handover and an SMS message by a base station according to an embodiment of the present disclosure.

Referring to FIG. 2B, the base station 100 may include a means 211 for receiving an SMS message for the first terminal. In addition, the base station 100 may include a means for establishing an RRC connection with the first terminal. In this case, an RRC connection message received from the first terminal may include information regarding a handover event type (e.g., condition information per event type).

In addition, the base station 100 may include a means 213 for running a timer for measuring a threshold time from when the SMS message is received. In particular, the base station 100 may include a means for running timers of respective terminals managed by the base station 100.

In addition, the base station 100 may include a means 215 for detecting a handover event occurrence with respect to the first terminal during the timer. In this case, the base station 100 may include a means for receiving a measurement report message from the terminal coupled to the base station, and may include a means for determining a handover event type based on the received measurement report message.

In addition, the base station 100 may include a means 217 for triggering a handover of the first terminal after the timer expires.

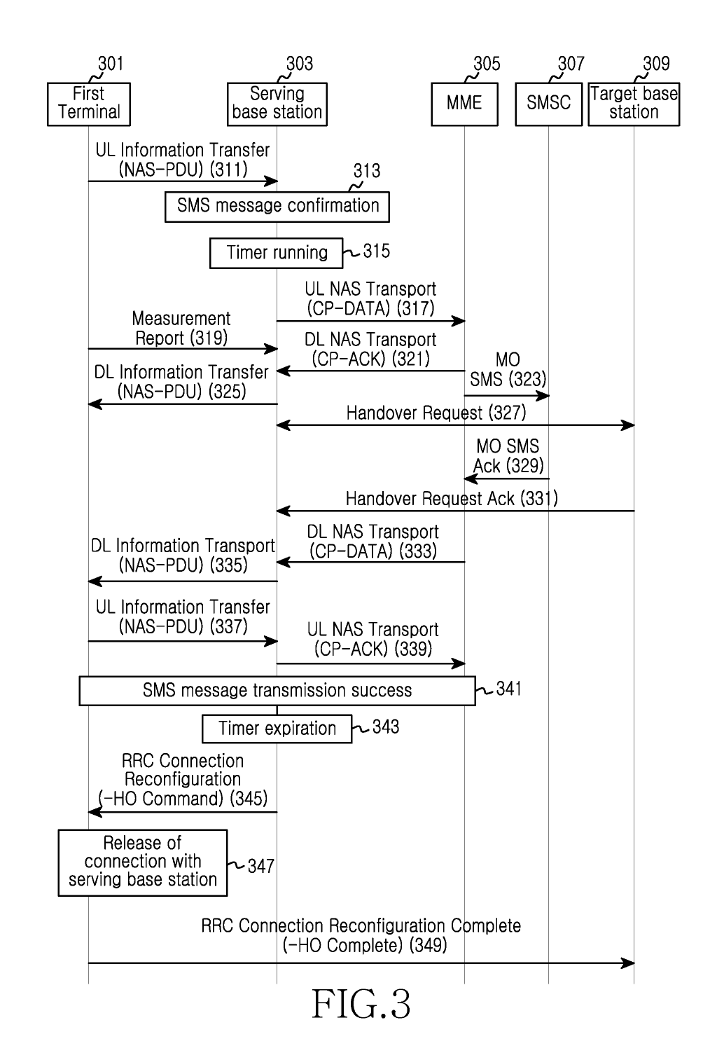

FIG. 3 illustrates a signal flow for transmitting an SMS message when a handover event is detected by a base station according to an embodiment of the present disclosure.

Referring to FIG. 3, a first terminal 301 requests (not shown) to transmit the SMS message, and thereafter reports an A3-type handover event occurrence. That is, the first terminal 301 may transmit to a serving base station 303 an uplink information message including an NAS Protocol Data Unit (PDU) in operation 311.

In operation 313, the serving base station 303 may confirm that the received uplink information message including the NAS PDU is an SMS message. More specifically, the serving base station 303 may confirm a protocol discriminator field included in the received NAS message indicates that the message is an SMS message.

In operation 315, the serving base station 303 may run a handover delay timer for delaying a handover during a pre-set time. In other words, if it is indicated that the received message is the SMS message, the serving base station 303 may run the handover delay timer and delay the handover while the first terminal 301 is transmitting and receiving the SMS message. In this case, the handover delay timer may be pre-set by considering a time required to transmit and receive an NAS message for an SMS message communication.

In operation 317, the serving base station 303 may transmit an uplink NAS message to an MME 305. In other words, the serving base station 303 may transmit the NAS message including Cyclic Prefix (CP) data to the MME 305.

Meanwhile, in operation 319, the first terminal 301 may transmit a measurement report message to the serving base station 303 for reporting a handover event occurrence. In this case, the received measurement report message may include information regarding a handover event type of the first terminal. For example, the received measurement report message may include information indicating whether the handover event type of the first terminal is an A3 type or an A5 type. In the embodiment of the present disclosure, it is assumed that the handover event type included in the measurement report message is A3.

In response to the uplink NAS message, the MME 305 transmits a downlink NAS message to the serving base station 303 in operation 321, and transmits a Mobile Originated (MO) SMS included in the uplink NAS message to an SMSC 307 in operation 323.

In operation 325, the serving base station 303 transmits a downlink information message to the first terminal 301, which includes the downlink NAS message received from the MME 305. Upon receiving the measurement report message in operation 319, since the handover delay timer is running and the handover event type is A3, the serving base station 303 may determine to delay a handover trigger until the handover delay timer expires. In operation 327, the serving base station 303 determines a target base station 309 based on the received measurement report message and transmits a handover request message to the target base station 309.

In operation 329, the SMSC 307 may transmit an MO SMS ACKnowledge (ACK) message to the MME 305, which is a response message for the MO SMS message received from the MME 305.

In operation 331, the target base station 309 transmits an ACK message to the serving base station 303 for a handover request in response to the handover request message received from the serving base station 303. In this case, the serving base station 303 waits until the handover delay timer expires, instead of transmitting the handover command message to the first terminal 301.

Upon receiving the MO SMS ACK message from the SMSC 307, the MME 305 transmits a downlink NAS message including ACK to the serving base station 303 in operation 33. In operation 335, the serving base station 303 transmits to the first terminal 301 a downlink information message including the NAS message. In response to the downlink information including the NAS message, the first terminal 301 transmits an uplink information message including an NAS PDU to the serving base station 303 in operation 337. In operation 339, the serving base station 303 may transmit an NAS message including the received uplink information to the MME 305. Accordingly, SMS message transmission may be successfully completed in operation 341.

The serving base station 303 detects expiration of the handover delay timer in operation 343, and transmits an RRC connection reconfiguration message to the first terminal 301 including a handover command in operation 345. In other words, after the handover delay timer expires, the serving base station 303 may then transmit a handover command message to the first terminal 301.

In operation 347, the first terminal 301 releases a connection with the serving base station 303. In operation 349, the first terminal 301 transmits an RRC connection reconfiguration complete message including a handover complete message to the target base station 309 so that a handover to the target base station 309 is performed.

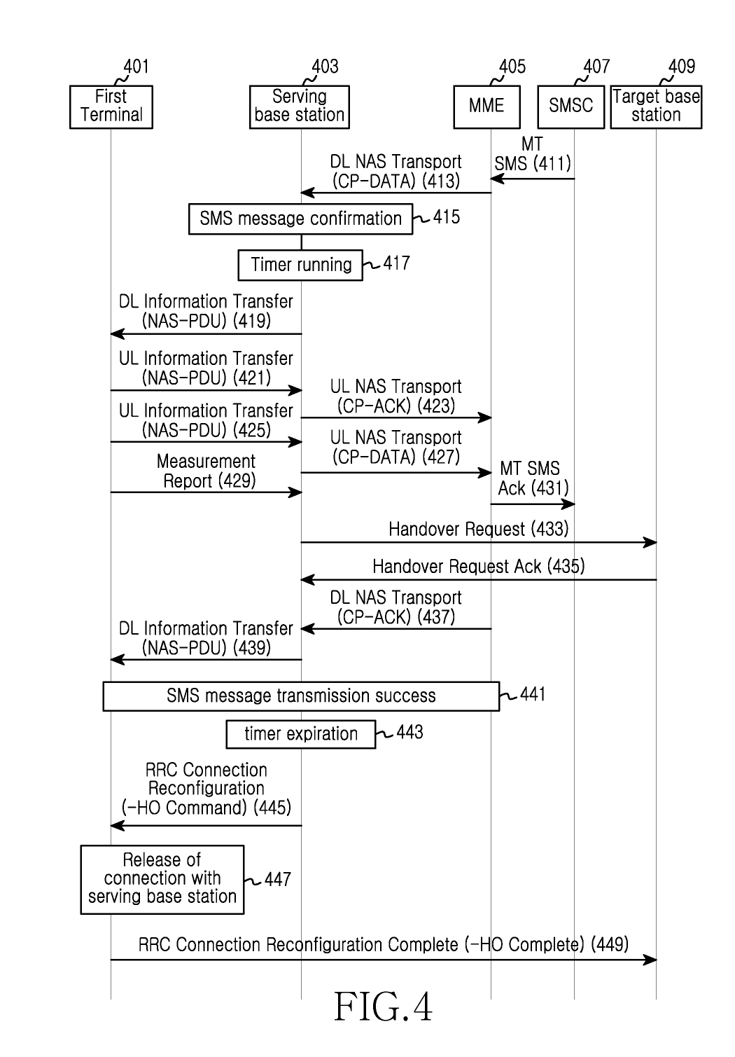

FIG. 4 illustrates a signal flow for transmitting an SMS message when a handover event is detected by a base station according to another embodiment of the present disclosure. It is assumed herein that an SMSC requests another terminal (not shown) to transmit the SMS message to a first terminal 401, and thereafter the first terminal 401 reports an A3-type handover event occurrence.

Referring to FIG. 4, an SMSC requests another terminal (not shown) to transmit the SMS message to a first terminal 401, and thereafter the first terminal 401 reports an A3-type handover event occurrence. Accordingly, in operation 411, an SMSC 407 transmits a Mobile Terminated (MT) SMS to an MME 405. In operation 413, the MME 405 transmits a downlink NAS message to a serving base station 403 which includes the received MT SMS as CP data.

In operation 415, the serving base station 403 may confirm that the received downlink NAS message is an SMS message. More specifically, the serving base station 403 may confirm a protocol discriminator field included in the received downlink NAS message indicates that the NAS message is an SMS message.

In operation 417, the serving base station 403 may run a handover delay timer for delaying a handover during a pre-set time. In other words, if it is indicated that the received message is an SMS message, the serving base station 403 may run the handover delay timer for delaying the handover during a procedure of transmitting and receiving the SMS message. In this case, the handover delay timer may be pre-set by considering a time required to transmit and receive an NAS message for an SMS.

In operation 419, the serving base station 403 transmits a downlink information message to the first terminal 401 including an NAS message. In operation 421, the first terminal 401 transmits an uplink information message to the serving base station 403 including an NAS PDU in response to the received downlink information message. In operation 423, the serving base station 403 transmits an uplink NAS message to the MME 405 including CP ACK. In addition, in operation 425, the first terminal 401 transmits an uplink information message to the serving base station 403 including an NAS PDU indicating that the received downlink information message is normally received. In operation 427, the serving base station 403 transmits an uplink NAS message to the MME 405 including CP data. In operation 431, the MME 405 transmits MT SMS ACK to the SMSC 407 to indicate that the MT SMS is transmitted to the first terminal 401.

Meanwhile, in operation 429, the first terminal 401 may transmit a measurement report message to the serving base station 403 for reporting a handover event occurrence. In this case, the received measurement report message may include information regarding a handover event type of the first terminal. For example, the received measurement report message may include information indicating whether the handover event type of the first terminal is an A3 type or an A5 type. In the present embodiment, it is assumed that the handover event type included in the measurement report message is A3.

In this example, because the handover delay timer is running and the handover event type is A3, upon receiving a measurement report message, the serving base station 403 may determine to delay a handover trigger until the handover delay timer expires. In operation 433, the serving base station 403 determines a target base station 409 on the basis of the measurement report message received from the first terminal and transmits a handover request message to the target base station 409.

In operation 435, the target base station 409 transmits an ACK message to the serving base station 403 for a handover request in response to the handover request message received from the serving base station 403. In this case, the serving base station 403 waits until the handover delay timer expires instead of transmitting the handover command message to the first terminal 401.

As noted above, the MME 405 transmits an MT SMS ACK message to the SMSC 407 in operation 431. Thereafter, in operation 437, the MME 405 transmits a downlink NAS message to the serving base station 403 including CP ACK. In operation 439, the serving base station 403 transmits to the first terminal 401 a downlink information message including an NAS PDU. Accordingly, SMS message transmission can be successfully complete in operation 441.

The serving base station 403 detects expiration of the running handover delay timer in operation 443 and transmits an RRC connection reconfiguration message to the first terminal 401 including a handover command in operation 445. In other words, after the handover delay timer expires, the serving base station 403 may transmit a handover command message to the first terminal 401

In operation 447, the first terminal 401 releases a connection with the serving base station 403. In operation 449, the first terminal 401 transmits an RRC connection reconfiguration complete message including a handover complete message to the target base station 409 so that a handover to the target base station 409 is performed.

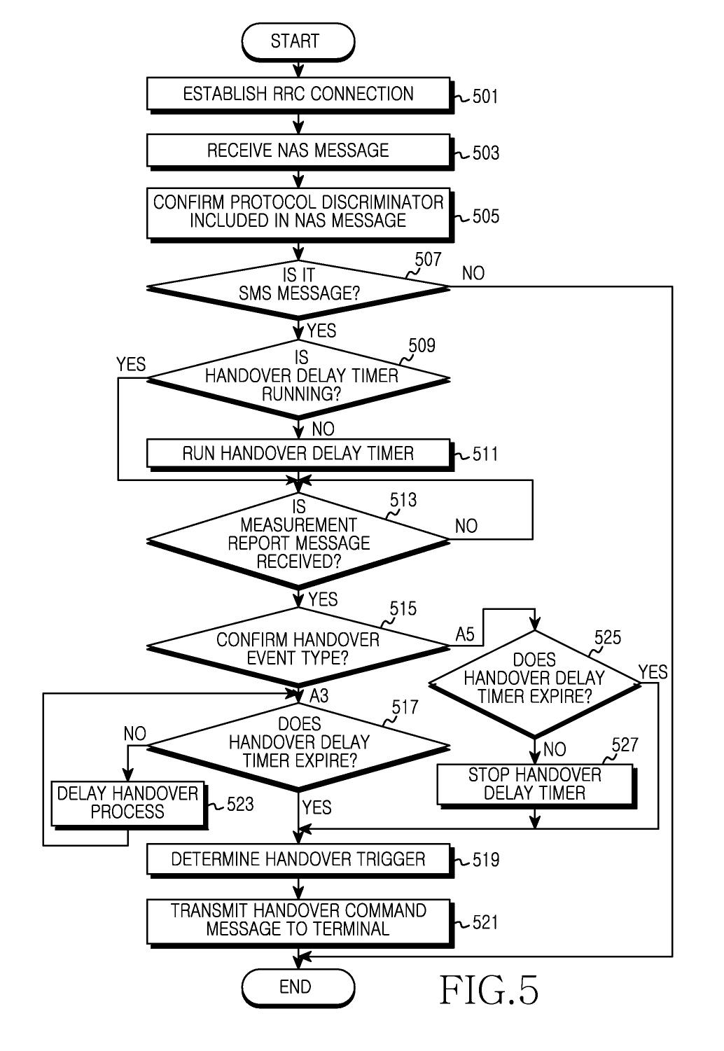

FIG. 5 is a flowchart illustrating a procedure for determining whether to perform a handover trigger on the basis of a handover event type when a handover event is detected according to an embodiment of the present disclosure. FIGS. 6A and 6B illustrate a frame structure of a NAS message according to an embodiment of the present disclosure.

Referring to FIG. 5, the base station 100 may establish an RRC connection in operation 501. In other words, the base station 100 may establish an RRC connection with a specific terminal to be coupled to the base station. In this case, the base station 100 may use an RRC connection reconfiguration message to transmit information regarding a handover event type to the terminal to which the RRC connection is to be established. For example, when the terminal to which the RRC connection is to be established performs a handover, the base station 100 may transmit information regarding an A3 type to the terminal so that the handover can be performed with the A3 type. In another example, when the terminal to which the RRC connection is to be established performs the handover, the base station 100 may transmit information regarding an A5 type to the terminal so that the handover can be performed with the A5 type.

In operation 503, the base station 100 may receive an NAS message. For example, the base station 100 may receive an uplink NAS message from the terminal coupled to the base station 100. In another example, the base station 100 may receive a downlink NAS message from the MME.

In operation 505, the base station 100 may confirm if a protocol discriminator is included in the NAS message. For example, the base station 100 may confirm a bit pattern of protocol discriminators 601 and 611 from the plain NAS message and the security protected NAS message shown in FIGS. 6A and 6B.

In operation 507, the base station 100 may confirm whether the protocol discriminator indicates that the message is an SMS message. As noted above, the base station 100 may confirm whether the protocol discriminator of the NAS message has a bit pattern ‘1001’ which indicates that the message is the SMS message. For example, as shown in FIG. 6A, if the plain NAS message is received, the base station 100 may confirm the protocol discriminator 601 included in the received plain NAS message and thus may confirm whether a corresponding identifier has a bit pattern ‘1001’, which indicates that the message is an SMS message. In another example, as shown in FIG. 6B, if the secure protected NAS message is received, the base station 100 may confirm if the protocol discriminator 611 is included in the received secure protected NAS message and thus may confirm whether a corresponding discriminator has a bit pattern ‘1001’, which indicates that the message is an SMS message.

If the protocol discriminator does not indicate that the message is the SMS message in operation 507, the base station 100 may end the procedure according to the embodiment of the present disclosure.

On the other hand, if the protocol discriminator indicates that the message is an SMS message in operation 507, the base station 100 determines whether a handover delay timer is running in operation 509.

If the handover delay timer is not running, the base station 100 may run the handover delay timer in operation 511. More specifically, the base station 100 may determine whether the handover delay timer is running if the SMS message is received and may run the handover delay timer for delaying a handover if the handover delay timer is not running. Referring back to operation 509, if the handover delay timer is running, the base station 100 may proceed to operation 513 described below.

In operation 513, the base station 100 may determine whether a measurement report message is received. In other words, the base station 100 may determine whether a measurement report message for a handover request is received from the terminal. However, if the measurement report message is not received in operation 513, the base station 100 repeats the operation 513 until the measurement report is received.

If the measurement report message is received from the terminal, the base station 100 may confirm a handover event type in operation 515. In this case, the received measurement report message may include information regarding the handover event type of the terminal. In other words, the base station 100 may confirm the handover event type of the terminal from the received measurement report message.

If the handover event type is an A3 type, the base station 100 may confirm whether the running handover delay timer expires in operation 517. If the handover delay timer has expired in operation 517, the base station 100 determines a handover trigger in operation 519 and may transmit a handover command message to the terminal in operation 521. Thereafter, the base station 100 may end the procedure according to the embodiment of the present disclosure.

Referring back to operation 517, if the handover delay timer has not expired, the base station 100 may delay a handover process in operation 523. Thereafter, operation 517 may cause the base station 100 to wait until the handover delay time expires. That is, if the handover event type is A3, the base station 100 may determine that the terminal can receive a service provided from a serving base station, and waits until the handover delay timer expires instead of transmitting the handover command message to the terminal so that the procedure of transmitting the SMS message can be successfully complete. When the handover delay timer expires, the base station 100 transmits the handover command message to the terminal so that the handover of the terminal is triggered.

Referring back to operation 515, if the handover event type is an A5 type, the base station 100 may confirm whether the handover delay timer expires in operation 525.

If the handover delay timer expires, the base station 100 may perform the subsequent operations by determining a handover trigger in operation 519 and transmitting a handover command message to the terminal in operation 521. Otherwise, if the handover delay timer does not expire in operation 525, the base station 100 may stop the handover delay timer in operation 527, determine a handover trigger in operation 519, and transmit a handover command message to the terminal in operation 521. More specifically, if the handover delay timer does not expire in a state where the handover event type is the A5 type, the base station 100 recognizes that the handover must be performed immediately after a handover preparation is complete because the terminal is no longer able to receive a service from the serving base station. Accordingly, the base station 100 stops the running handover delay timer and thereafter determines a handover trigger and transmits a handover command message to the terminal.

Although not explained in the aforementioned procedure, upon receiving an NAS message, the base station 100 may process the NAS message according to a well-known technique during the aforementioned procedures are performed. In this case, the procedure of transmitting and receiving the NAS message must end before the handover delay timer expires.

Each of the aforementioned elements of the electronic device according to various embodiments of the present disclosure may consist of one or more components, and names thereof may vary depending on a type of the electronic device. The electronic device according to various embodiments of the present disclosure may include at least one of the aforementioned elements. Some of the elements may be omitted, or additional other elements may be further included. In addition, some of the elements of the electronic device according to various embodiments of the present disclosure may be combined and constructed as one entity, so as to equally perform functions of corresponding constitutional elements before combination.

A term “module” used in various embodiments of the present disclosure may imply a unit including, for example, one of hardware, software, and firmware or any suitable combination. The “module” may be interchangeably used with a term such as a unit, logic, a logical block, a component, a circuit, and the like. The “module” may be a minimum unit of an integral component or may be a part thereof. The “module” may be a minimum unit for performing one or more functions or may be a part thereof. The “module” may be mechanically or electrically implemented. For example, the “module” according to various embodiments of the present disclosure may include at least one of an Application-Specific Integrated Circuit (ASIC) chip, a Field-Programmable Gate Arrays (FPGAs), and a programmable-logic device, which are known or will be developed and which perform certain operations.

According to various embodiments of the present disclosure, at least some parts of a device (e.g., modules or functions thereof) or method (e.g., operations) based on the various embodiments of the present disclosure may be implemented with an instruction stored in a non-transitory computer-readable storage media for example. If the instruction is executed by one or more processors (e.g., a processor), the one or more processors may perform a function corresponding to the instruction. The non-transitory computer-readable storage media may be, for example, a memory. At least some parts of the programming module may be implemented (e.g., executed), for example, by the processor. At least some parts of the programming module may include modules, programs, routines, sets of instructions, processes, and the like, for performing one or more functions.

The non-transitory computer readable recording medium may be a hardware device configured particularly to store and perform a program instruction (e.g., program module), for example, a hard disk, a magnetic medium such as a floppy disc and a magnetic tape, an optical storage medium such as a Compact Disc-ROM (CD-ROM) or a Digital Versatile Disc (DVD), a magnetic-optic medium such as a floptical disc, a Read Only Memory (ROM), a Random Access Memory (RAM), a flash memory, and the like. An example of the program instruction includes not only a machine language created by a compiler but also a high-level language executable by a computer by using an interpreter or the like. The aforementioned hardware device may be configured to operate as one or more software modules to perform the operation of various embodiments of the present disclosure, and the other way around is also possible.

The module or programming module according to various embodiments of the present disclosure may further include at least one or more components among the aforementioned components, or may omit some of them, or may further include additional other components. Operations performed by a module, programming module, or other components of the various embodiments of the present disclosure may be executed in a sequential, parallel, repetitive, or heuristic manner. In addition, some of the operations may be executed in a different order or may be omitted, or other operations may be added.

According to various embodiments of the present disclosure, in a storage medium having instructions stored therein, the instructions are configured such that at least one operation is performed by at least one processor when executed by the at least one processor. The at least one operation may include operations of transmitting or receiving at least one signal between a first signal corresponding to a first communication network and a second signal corresponding to a second communication network in an electronic device; and if the at least one signal is received, distributing the at least one signal to each of a first communication control module for processing the first signal and a second communication control module for processing the second signal, on the basis of a fact that a service provided by the electronic device corresponds to the first signal and the second signal.

While the present disclosure has been shown and described with reference to various embodiments thereof, it will be understood by those skilled in the art that various changes in form and details may be made therein without departing from the spirit and scope of the present disclosure as defined by the appended claims and their equivalents. Therefore, the scope of various exemplary embodiments of the present invention are defined not by the detailed description of the various exemplary embodiments of the present invention but by the appended claims, and all differences within the scope will be construed as being included in the various exemplary embodiments of the present invention.

What is claimed is:

1. A method for transmitting a Short Message Service (SMS) message by a base station, the method comprising:
receiving the SMS message for a first terminal;
in response to receiving the SMS message, detecting a handover event for the first terminal during a predetermined time; and
if the handover event is detected, triggering a handover of the first terminal after the predetermined time.

2. The method of claim 1, further comprising:
running a timer for measuring the predetermined time from when the SMS message is received.

3. The method of claim 2, wherein the triggering of the handover of the first terminal comprises transmitting a handover command message to the first terminal after the timer expires.

4. The method of claim 3, wherein the triggering of the handover of the first terminal comprises:
after detecting the handover event for the first terminal, transmitting a handover request message to a handover target base station of the first terminal;
receiving a handover response message from the target base station; and
in lieu of transmitting the handover command to the first terminal, waiting until the timer expires.

5. The method of claim 2, further comprising performing an SMS message transmission procedure before the timer expires, wherein the timer corresponds to a time required to complete the SMS message transmission procedure.

6. The method of claim 1, wherein the receiving of the SMS message for the first terminal comprises:
receiving a Non Access Stratum (NAS) message one of a terminal and a higher network node; and
determining that the NAS message is the SMS message based on a protocol discriminator contained in the NAS message.

7. The method of claim 1, wherein the detecting of the handover event for the first terminal during the predetermined time comprises receiving a measurement report message for reporting the handover event from the first terminal.

8. The method of claim 1, further comprising:
detecting a type of the handover event; and
determining a handover trigger time based on the type of the handover event.

9. The method of claim 8, wherein the determining of the handover trigger time based on the type of the handover event comprises, based on the type of the handover event, determining at least one of the handover trigger time corresponding to a timer expiration time and the handover trigger time being substantially less than the timer expiration time.

10. The method of claim 8, wherein the type of the handover event is detected based on event type information in a measurement report message received from the first terminal.

11. A base station for transmitting a Short Message Service (SMS) message, the base station comprising:
a communicator configured to transmit and receiving a message;
an SMS transmission controller configured to receive the SMS message for a first terminal; and
a handover controller configured to detect a handover event for the first terminal during a predetermined time, in response to receiving the SMS message, and if the handover event is detected, to trigger a handover of the first terminal after the predetermined time.

12. The base station of claim 11, wherein the handover controller runs a timer for measuring the predetermined time from when the SMS message is received.

13. The base station of claim 12, wherein the handover controller triggers the handover of the first terminal by transmitting a handover command message to the first terminal after the timer expires.

14. The base station of claim 13, wherein the handover controller transmits a handover request message to a handover target base station of the first terminal after detecting the handover event for the first terminal, and, in lieu of transmitting the handover command to the first terminal, waits until the timer expires.

15. The base station of claim 12, wherein the SMS transmission controller performs an SMS message transmission procedure before the timer expires, and the timer corresponds to a time required to complete the SMS message transmission procedure.

16. The base station of claim 11, wherein the SMS transmission controller receives a Non Access Stratum (NAS) message one of a terminal and a higher network node, and determines that the NAS message is the SMS message based on a protocol discriminator contained in the NAS message.

17. The base station of claim 11, wherein the handover controller receives a measurement report message for reporting the handover event from the first terminal during the predetermined time and detects a handover event based on the measurement report message.

18. The base station of claim 11, wherein the handover controller detects a type of the handover event and determines a handover trigger time based on the type of the handover event.

19. The base station of claim 18, wherein the handover controller determines at least one of the handover trigger time corresponding to a timer expiration time and the handover time being substantially less than the timer expiration time based on the type of the handover event.

20. The base station of claim 18, wherein the handover controller detects a type of the handover event based on event type information contained in a measurement report message received from the first terminal.
